(19) United States
(12) Patent Application Publication
(10) Pub. No.: US 2015/0083642 A1
(43) Pub. Date: Mar. 26, 2015

(54) CONTAINER WITH AN EXTERIOR REVERSIBLE STRIP AND METHOD FOR MAKING THE SAME

(71) Applicant: GLAMGLOW Inc., Los Angeles, CA (US)

(72) Inventors: Glenn Dellimore, Encino, CA (US); Shannon Beth Dellimore, Encino, CA (US)

(21) Appl. No.: 14/494,544

(22) Filed: Sep. 23, 2014

Related U.S. Application Data
(60) Provisional application No. 61/881,285, filed on Sep. 23, 2013.

(51) Int. Cl. B65D 5/44; G09F 23/00

(52) U.S. Cl. CPC B65D 5/441; G09F 23/00; G09F 2023/0025
USPC 206/736; 29/428

(57) ABSTRACT

A display container with a reversible exterior strip is described. The display container includes a box having at least two box parts, each box part having an interior and exterior sides. At least one elongated reversible strip is included. The elongated strip has a first side and a second side and is attached with the exterior sides of both box parts such that the box parts can be rotated with respect to one another into a first closed position to display the first side of the elongated strip and then rotated into a second closed position which reverses the elongated reversible strip and displays the second side of the reversible strip.

### CROSS-REFERENCE TO RELATED APPLICATIONS

This is a non-provisional application of U.S. Provisional Application No. 61/881,285, filed on Sep. 23, 2013, entitled, “Container with Reversible Exterior Strip.”

### BACKGROUND OF THE INVENTION

(1) Field of Invention

The present invention relates to a container and, more particularly, to a product container having at least one exterior reversible strip.

(2) Description of Related Art

Containers have long been known in the art and are often used to display a variety of objects. While operable for displaying the contents therein, typical display containers or display boxes have fixed external artwork or copy. Such fixed external artwork or copy allows the retailer, manufacturer, etc., to convey a single message or design. Should the manufacturer, etc., decide to alter or otherwise change the exterior packaging message or design, the manufacturer must typically incur the cost of redesigning and replacing the packaging to alter its exterior appearance. As can be appreciated, such a process can be costly and cumbersome.

Thus, a continuing need exists for a display container that allows a user to easily alter or reverse the artwork or copy on the exterior of the container.

### SUMMARY OF THE INVENTION

A display container with one or more reversible exterior strips is described. In one aspect, the container includes a first part and a second part, each of the first part and second part having an interior and an exterior. Also included is a first reversible strip, the first reversible strip having a first side and a second side and being attached with the first part and second part such that the first part and second part can be rotated with respect to one another into a first closed position to display the first side of the first reversible strip and then rotated into a second closed position which reverses the first reversible strip and displays the second side of the first reversible strip.

In another aspect, a second reversible strip and third reversible strip are included. The first, second, and third reversible strips each include at least two wings. Additionally, the first and second reversible strips are positioned around the exterior of the first part, with the wings of the first and second reversible strips being attached with the interiors of both the first and second parts, and the third reversible strip is positioned around the exterior of the second part, with the wings of the third reversible strip being attached with the interiors of both the first and second parts.

In another aspect and as can be appreciated by one in the art, the present invention also comprises a method for forming and using the invention described herein.

For example, the method for forming a container with exterior reversible strips, comprising acts of positioning a first reversible strip around an exterior of a first part such that wings of the first reversible strip extend beyond edges of the first part; positioning a second reversible strip around an exterior of the first part such that wings of the second reversible strip extend beyond edges of the first part; positioning a third reversible strip such that a wing of the third reversible strip lays under an edge of the first part; positioning a second part adjacent the first part, with the third reversible strip being positioned around an exterior of the second part; affixing the wings of the first reversible strip to an interior of the first part and an interior of the second part, affixing the wings of the second reversible strip to the interior of the first part and the interior of the second part; and affixing the wings of the third reversible strip to the interior of the first part and the interior of the second part.

Finally, another aspect includes a method for using the container. The method comprising acts of rotating the two parts around with respect to one another to alter the surface of the reversible strips that is displayed externally.

### BRIEF DESCRIPTION OF THE DRAWINGS

The objects, features and advantages of the present invention will be apparent from the following detailed descriptions of the preferred aspect of the invention in conjunction with reference to the following drawings, where:

FIG. 1 is an illustration depicting a container having first and second parts and reversible strips according to the principles of the present invention;

FIG. 2 is an illustration depicting a first reversible strip being laid over the first part according to the principles of the present invention, showing wings extending beyond edges of the first part;

FIG. 3 is an illustration depicting a second reversible strip being laid over the first part according to the principles of the present invention, showing wings extending beyond edges of the first part;

FIG, 4 is an illustration depicting a third reversible strip being positioned such that a wing of the third reversible strip lays under an edge of the first part;

FIG. 5 is an illustration depicting a second part being positioned next to the first part, with the third reversible strip being laid over the second part;

FIG. 6 is an illustration depicting an interior view of the first and second parts, showing the wings of the reversible strips extending beyond the edges of the first and second parts;

FIG. 7 is an illustration depicting an interior view of the first and second parts, showing the wings of the reversible strips being affixed inside of the first and second parts;

FIG. 8 is an illustration depicting an exterior of the first and second parts, showing a first side of the reversible strips;

FIG. 9 is an illustration depicting the first and second parts in a closed position and showing the first side of the reversible strips;

FIG. 10 is an illustration depicting a process of reversing the reversible strips, showing the first and second parts being opened;

FIG. 10 is an illustration depicting a process of reversing the reversible strips, showing the first and second parts being rotated with respect to one another to expose a second side of the reversible strips;

FIG. 11 is an illustration depicting a process of reversing the reversible strips, showing the first and second parts being rotated with respect to one another;

FIG. 12 is an illustration depicting a process of reversing the reversible strips, showing the first and second parts being rotated with respect to one another;

FIG. 13 is an illustration depicting a process of reversing the reversible strips, showing the first and second parts being rotated with respect to one another to expose the second side of the reversible strips;

FIG. 14 is an illustration depicting a process of reversing the reversible strips, showing the first and second parts being rotated with respect to one another to expose the second side of the reversible strips; and

FIG. 15 is an illustration depicting the first and second parts in a closed position and showing the second side of the reversible strips.

### DETAILED DESCRIPTION

The present invention relates to a display box and, more particularly, to a display container having at least one exterior reversible strip. The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the present invention is not intended to be limited to the embodiments presented, but is to be accorded the widest scope consistent with the principles and novel features disclosed herein.

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is only one example of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the claims herein is not intended to invoke the provisions of 35 U.S.C. 112, Paragraph 6.

Please note, if used, the labels left, right, front, back, top, bottom, forward, reverse, clockwise and counter clockwise have been used for convenience purposes only and are not intended to imply any particular fixed direction. Instead, they are used to reflect relative locations and/or directions between various portions of an object.

(1) Description

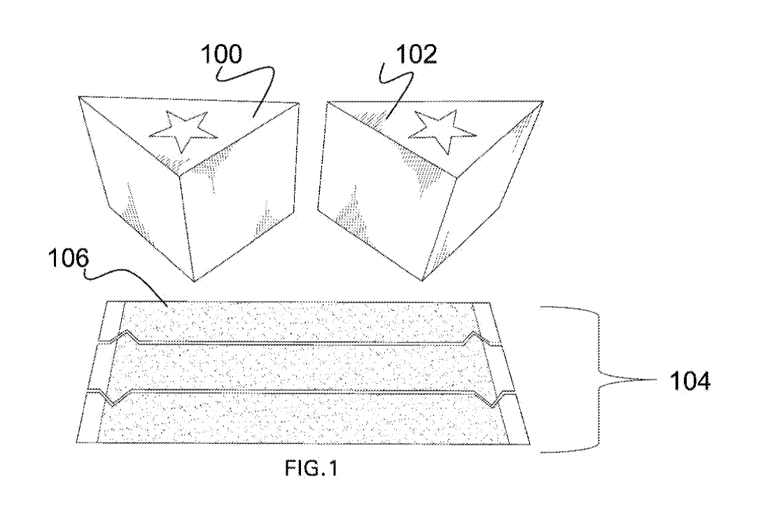

Described is a display container that allows a user to easily alter or reverse the artwork, copy, or design as displayed on the exterior of the container while containing a product or item therein. Specifically, the container includes one or more reversible strips positioned around the exterior of the container. The strips include copy, design, artwork, or any other message or design that is desirably conveyed to a consumer or user. In operation, a user can easily manipulate the container which, through said manipulation, causes the reversible strips to be effectively turned around and change the side of the strip that faces externally. By selectively altering the side of the strip that is externally positioned, a user can selectively alter the copy, design, artwork, etc. that is conveyed on the particular container. For further, understanding, FIGS. 1 through 15 illustrate a process of forming and manipulating the container according to the principles of the present. It should be noted that the term “reversible strip” is used for convenience purposes only and that it is not necessarily a strip (although it can be in one aspect) and can be any elongated component that provides the features as described below. It should also be noted that although the invention is described and illustrated as having three elongated reversible strips (e.g., paper, plastic, foil, etc.), the invention is not intended to be limited thereto as any suitable number can be included. Thus, the number of reversible strips can be increased or decreased as desired, and can be altered (increased, decreased, shaped differently, etc.) to change the length or dimension on the container. Additionally, the container shape can be changed as desired. Further, although the term “paper” may be used, the invention is not intended to be limited to paper and can be formed using plastic, metal, or any other suitable material.

For further understanding and as shown in FIG. 1, the container includes a first part 100 and a second part 102 (or any suitable number of parts). The first part 100 and second parts 102, when attached with one another, collectively form the container. It should be understood that the first and second parts 100 and 102 can be formed in any suitable shape such that they can be attached with one another to collectively form the container, a non-limiting example of which includes being a square or rectangular box (i.e., the container shape) that is divided diagonally into two equal triangular box parts (i.e., the first part 100 and second part 102) as shown in FIG. 1.

Also shown are a plurality of reversible ships 104 (e.g., reversible strips). Notably, each reversible strip has a first side 106 and a second side (not shown). Each of the first side 106 and second sides can be provided with the same or different copy, artwork, or design as desired. In one aspect, the reversible strips 104 can be separately formed or, in another aspect, can be cut from a single sheet (as shown in FIG. 1).

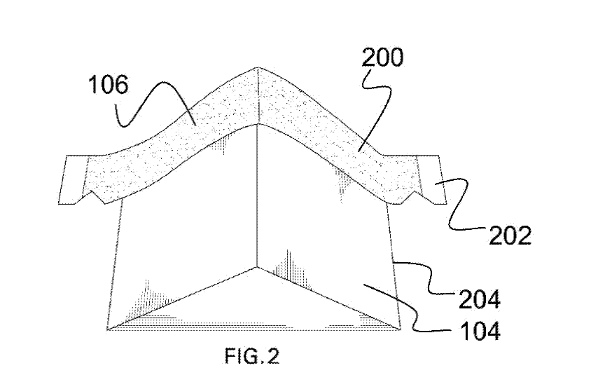

FIG. 2 illustrates the process of forming the container. As shown, the first part 100 is laid on its face and a first reversible strip 200 is laid over the first part 100 such that the first side 106 is shown. The first reversible strip 200 is sufficiently long such that it includes wings 202 that extend beyond edges 204 of the first part 100.

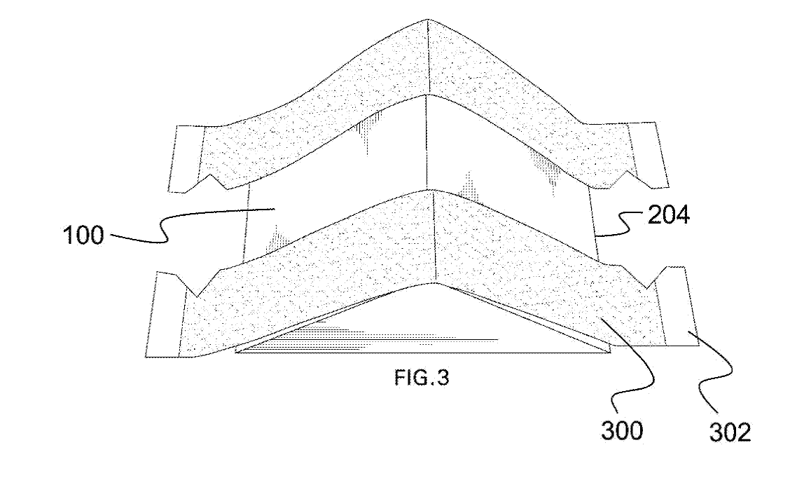

FIG. 3 illustrates a second reversible strip 300 being laid over the first part 100. Again, the second reversible strip 300 is sufficiently long such that it includes wings 302 that extend beyond edges 204 of the first part 100.

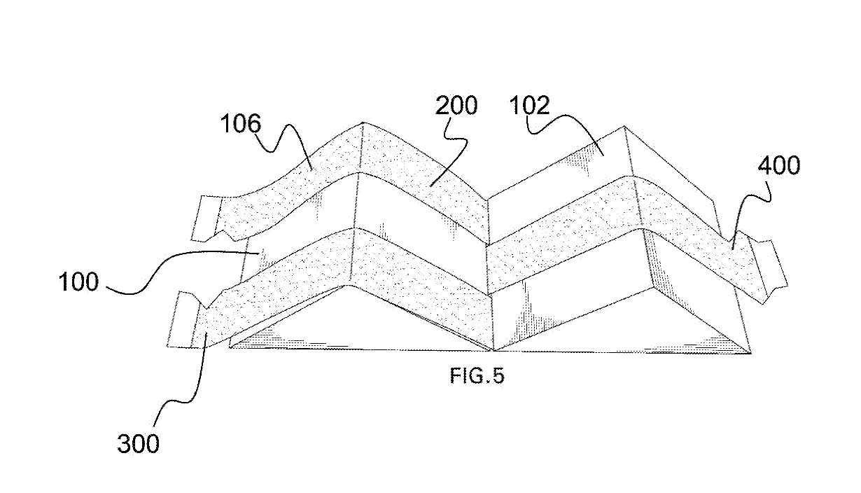

Next and as shown in FIG. 4, a third reversible strip 400 is attached with the first part 100 such that a wing (shown as element 402 in FIG. 6) lays under the edge 204 of the first part 100. It should be noted that any suitable number of reversible strips can be employed according to the principles of the present invention; however, desirably, at least three reversible strips are employed as shown.

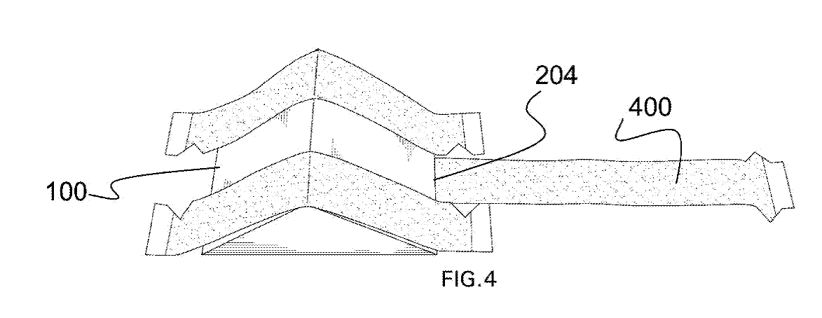

As shown in FIG. 5, the second part 102 is introduced such that it is positioned next to the first part 100. Importantly, the second part 102 sits on top of the first reversible strip 200 and second reversible strip 300, with the third reversible strip 400 being laid over the second part 102.

As shown in FIG. 6, the first and second parts 100 and 102 are flipped to their side to reveal the interior 601 of the first and second parts 100 and 102. Notably, when flipped on their side or otherwise turned over, the wings 202, 302 and 402 of the reversible strips 200, 300, and 400 extend beyond the edges of the first and second parts 100 and 102. It should be noted that, in one aspect, the term wings 202, 302, and 402 is used to describe that the reversible strips 200, 300, and 400 are sufficiently long such that they extend beyond the exterior of the relevant first and second parts 100 and 102, with the portion of the reversible strips 200, 300, and 400 that are long enough to be wrapped into the interior 601 and adhered therein being referred to and illustrated as the wings 202, 302, and 402.

It should also be noted that while FIG. 5 illustrates a first side 106 of the strips 200, 300, and 400, FIG. 6 illustrates the second side 600 of the strips 200, 300, and 400.

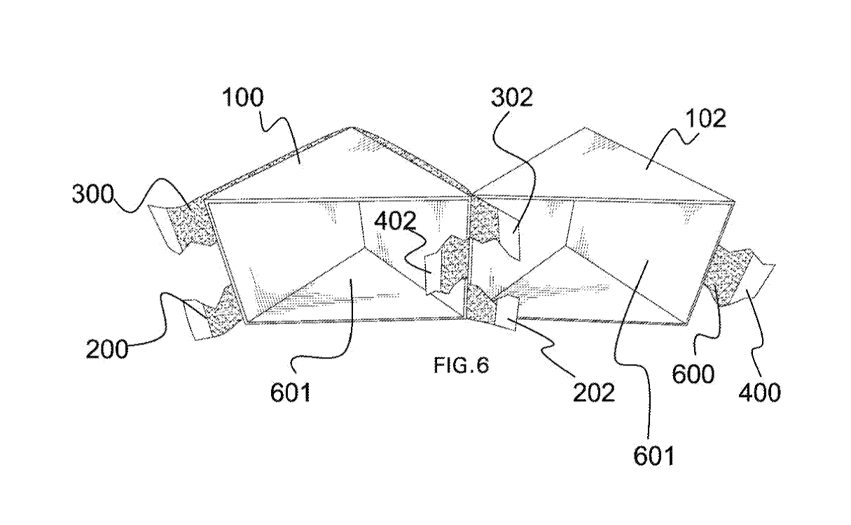

As shown in FIG. 7, the reversible strips 200, 300, and 400 are secured to the first and second parts 100 and 102 by pulling the wings 202, 302, and 402 tight and folding the wings 202, 302, and 402 around to the inside of the first and second parts 100 and 102 (where the wings 202, 302, and 402 are affixed). The wings 202, 302, and 402 are affixed to the inside of the first and second parts 100 and 102 using any suitable mechanism, technique, or device for attaching two components with one another, a non-limiting example of which includes using a glue or other adhesive. After the wings 202, 302, and 402 are affixed to the inside of the first and second parts 100 and 102, the container and strips are now secured and ready for use.

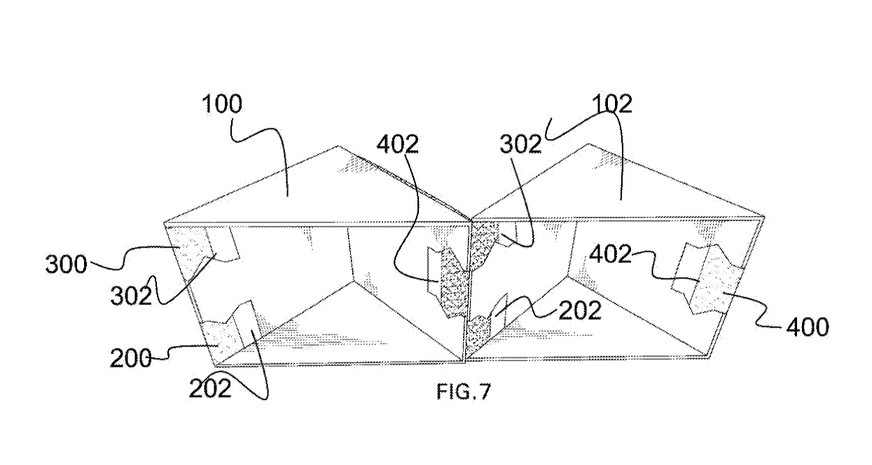

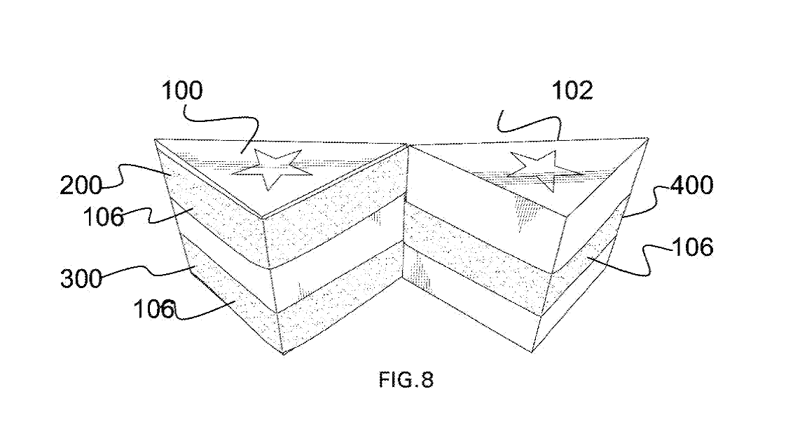

For example and as shown in FIG. 8, the container is illustrated with the first and second parts 100 and 102 in an open position. As shown, the first side 106 of the reversible strips 200, 300, and 400 is displayed to a user or consumer. For further understanding, FIG. 9 illustrates the container with the first and second parts 100 and 102 in a closed position, depicting the exterior 901 of the first and second parts 100 and 102 and showing the first side 106 of the reversible strips 200, 300, and 400.

As noted above, the container provides the user the ability to selectively reverse the reversible strips 200, 300, and 400 and, in doing so, change the design, artwork, copy, etc., that is displayed to a user. In order to reverse the strips 200, 300, and 400, the user begins by rotating 900 one edge of the first and second parts 100 and 102 away from each other and around a first axis 902.

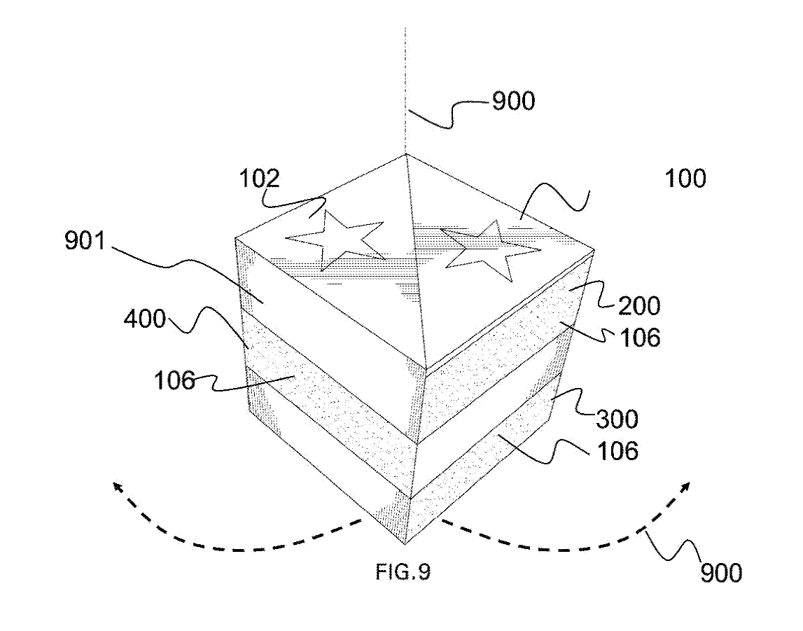

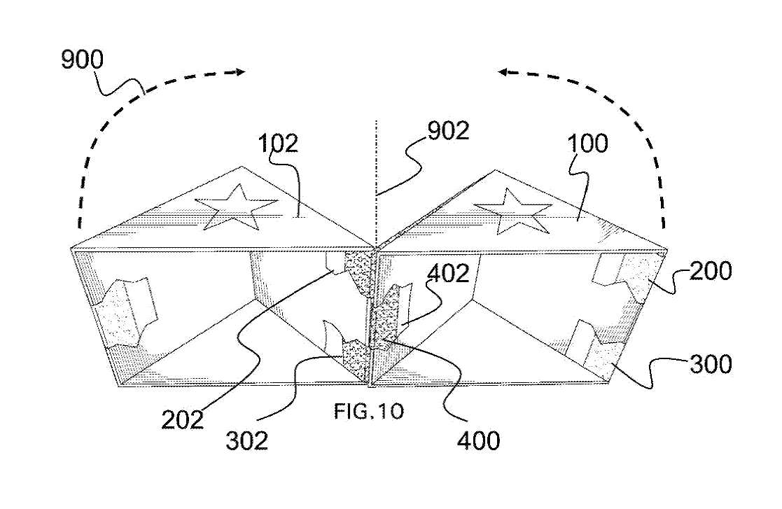

As shown in FIG. 10, the user can continue to rotate 900 the first and second parts 100 and 102 about the first axis 902. As shown, the axis 900 of rotation is formed because the first part 100 is connected with the second part 102 by virtue of the reversible strips 200, 300, and 400 that are laid over one of the first and second parts 100 and 102 with wings 202, 302, and 402 that extend across and are affixed with the opposite of the first and second parts 100 and 102. For example, the first reversible strip 200 rests against the outside of the first part 100. The wing 202 of the first part passes into inside of the second part 102, where it is affixed with the second part 102.

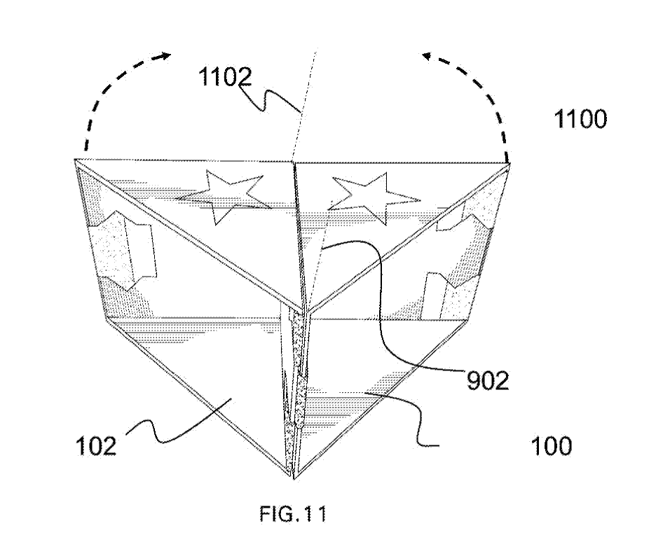

FIG. 11 illustrates continued rotation of the first and second parts 100 and 102 about the first axis 902 of rotation until the first and second parts 100 and 102 come to rest against one another (i.e., folds back onto itself as shown in FIG. 11). At that point, the first and second parts 100 and 102 can than continue to be rotated 1100 about a second axis 1102 of rotation.

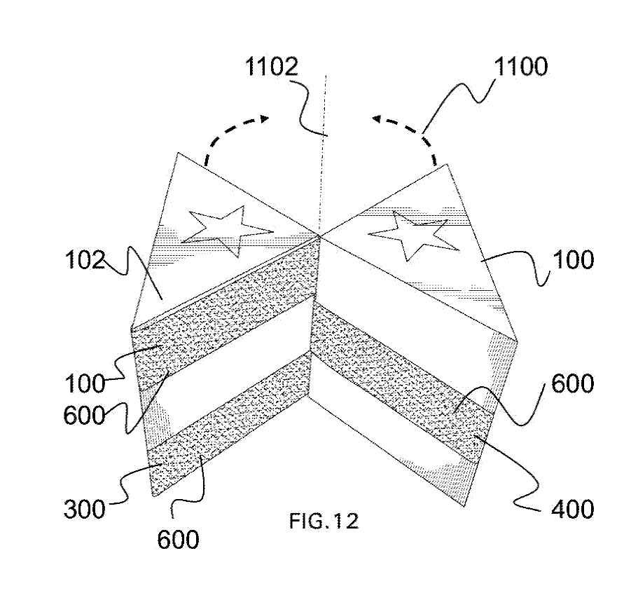

As shown in FIG. 12, when the first and second parts 100 and 102 continue to rotate 1100 about the second axis 1102 of rotation, the second side 600 of the strips 200, 300, and 400 is exposed.

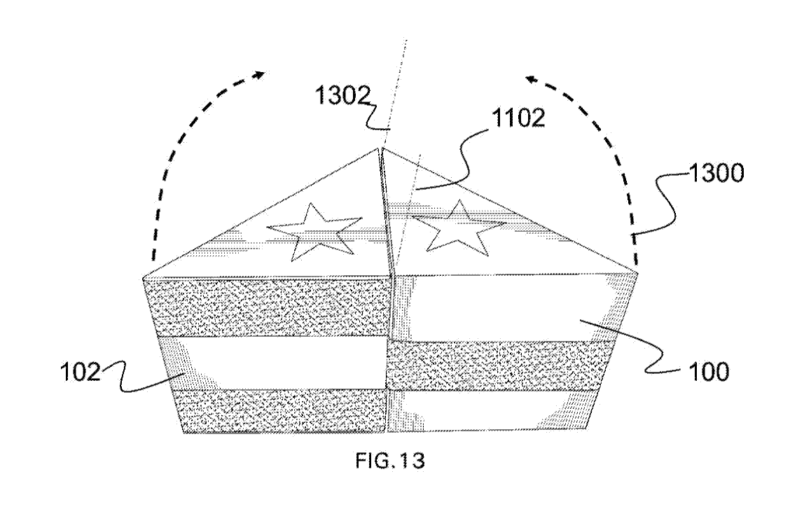

Further, FIG. 13 illustrates continued rotation of the first and second parts 100 and 102 about the second axis 1102 of rotation until the first and second parts 100 and 102 come to rest against one another again (as shown in FIG. 13). At that point, the first and second parts 100 and 102 can then continue to be rotated 1300 about a third axis 1302 of rotation.

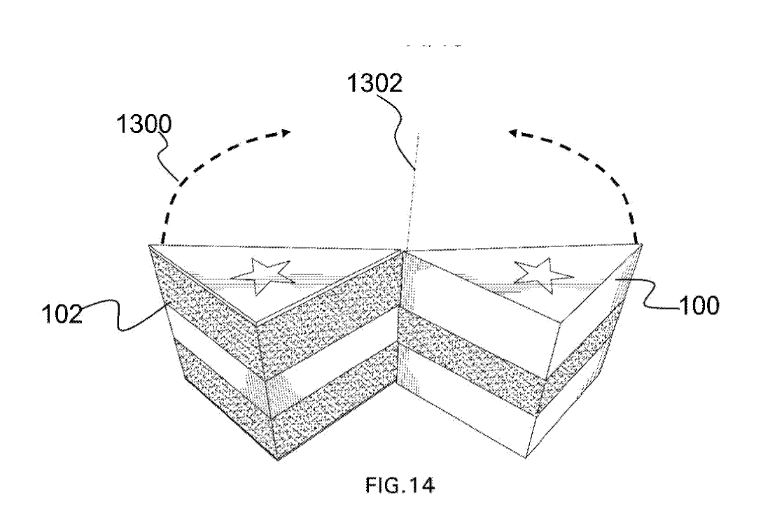

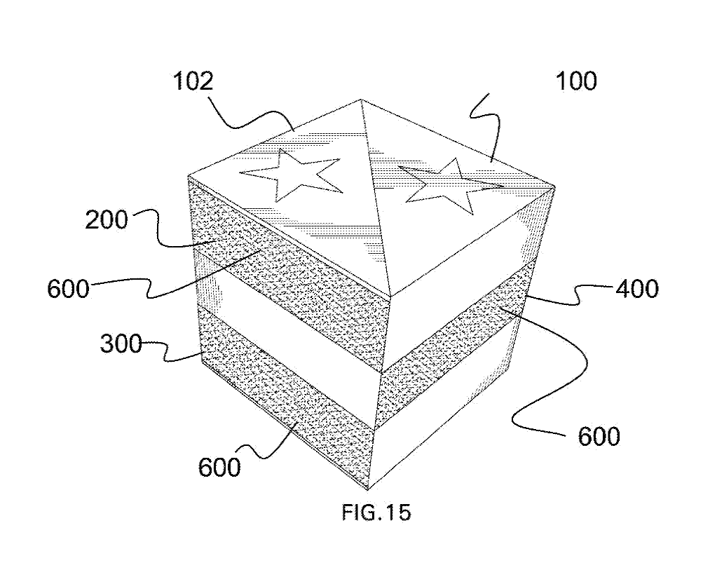

As shown in FIG. 14, the first and second parts 100 and 102 can continue to be rotated 1300 about the third axis 1302 of rotation until they come to rest against one another as shown in FIG. 15. Notably, FIG. 15 shows the container with the first and second parts 100 and 102 in a closed position and fully reversed (as compared to that as shown in FIG. 9). In other words, the reversible strips 200, 300, and 400 are now fully reversed such that the second side 600 of each strip is fully exposed and displayed to a user or consumer. Thu, as can be appreciated, a user can rotating the first and second parts 100 and 102 with respect to one another which allows the user to selectively display the first side 106 or second side 600 of the reversible strips 200, 300, and 400.

In another aspect, any suitable connector device can be included to assist the first and second parts 100 and 102 in maintaining the closed position. A non-limiting example of such a connector device includes polarity keyed magnets that are attached with the first and second parts 100 and 102 such that first part 100 is magnetically attached with the second part 102 when in the closed position. Such magnets can be glued or otherwise affixed at any suitable location within each of the parts 100 and 102.

Further, it should be understood that the method described above is but one example of a technique for forming the container according to the principles of the present invention and, as such, is not intended to be limited thereto as the container can be formed using a variety of techniques or processes and arrive at the container described herein. Thus, the present invention is not intended to be limited to the embodiments presented, but is to be accorded the widest scope consistent with the principles and novel features disclosed herein.

What is claimed is:

1. A container with exterior reversible strips, comprising:
a first part and a second part, each of the first part and second part having an interior and an exterior.
a first reversible strip, the first reversible strip having a first side and a second side and being attached with the first part and second part such that the first part and second part can be rotated with respect to one another into a first closed position to display the first side of the first reversible strip and then rotated into a second closed position which reverses the first reversible strip and displays the second side of the first reversible strip.

2. The container as set forth in claim 1, further comprising a second reversible strip and third reversible strip, where the first, second, and third reversible strips each include at least two wings, and wherein the first and second reversible strips are positioned around the exterior of the first part, with the wings of the first and second reversible strips being attached with the interiors of both the first and second parts, and wherein the third reversible strip is positioned around the exterior of the second part, with the wings of the third reversible strip being attached with the interiors of both the first and second parts.

3. A method for forming a container with exterior reversible strips, comprising acts of:
positioning a first reversible strip around an exterior of a first part such that wings of the first reversible strip extend beyond edges of the first part;
positioning a second reversible strip around an exterior of the first part such that wings of the second reversible strip extend beyond edges of the first part;
positioning a third reversible strip such that a wing of the third reversible strip lays under an edge of the first part;
positioning a second part adjacent the first part, with the third reversible strip being positioned around an exterior of the second part;
affixing the wings of the first reversible strip to an interior of the first part and an interior of the second part;
affixing the wings of the second reversible strip to the interior of the first part and the interior of the second part; and
affixing the wings of the third reversible strip to the interior of the first part and the interior of the second part.

4. A container with exterior reversible strips formed according to the method of claim 3.
